(19) United States
(12) Patent Application Publication
(10) Pub. No.: US 2026/0063842 A1
(43) Pub. Date: Mar. 5, 2026

(54) Optical Waveguide

(71) Applicant: NTT, Inc., Tokyo (JP)

(72) Inventors: Kenya Suzuki, Musashino-shi, Tokyo (JP); Yu Kurata, Musashino-shi, Tokyo (JP); Keita Yamaguchi, Musashino-shi, Tokyo (JP)

(21) Appl. No.: 19/105,282

(22) PCT Filed: Aug. 22, 2022
(86) PCT No.: PCT/JP2022/031618

§ 371 Date: Feb. 20, 2025

(51) Int. Cl. G02B 6/122

(52) U.S. Cl. CPC G02B 6/122

(57) ABSTRACT

Provided is an optical waveguide capable of suppressing optical loss in a groove portion into which a wavelength plate is inserted while eliminating polarization dependence. An optical waveguide according to the present disclosure is an embedded optical waveguide formed on a substrate, including a lower cladding; a core; an upper cladding; and a groove formed on one side of a side surface of the core with respect to a light propagation direction and extending in a direction parallel to the core, wherein a refractive index distribution in a plane perpendicular to the light propagation direction is a distribution in which a principal axis of a refractive index ellipse has a rotation amount with respect to a horizontal direction of the substrate.

### TECHNICAL FIELD

The present disclosure relates to an optical waveguide, and more particularly, to an embedded optical waveguide formed on a substrate.

### BACKGROUND ART

Due to the explosive spread of data communication networks such as the Internet, increasing a capacity of optical communication networks is desired. In order to respond to such increased demand for networks, various optical devices have been put into practical use, such as an optical variable attenuator and a coherent communication front end. Optical waveguides play a key role in allowing fabrication of these optical devices due to allowing high integration and manufacturability.

FIG. 1 is a top view schematically illustrating a configuration of an optical variable attenuator 100 in which a Mach-Zehnder interferometer configured on an optical waveguide circuit is connected in two stages according to the prior art. As an example of the optical waveguide described above, the optical variable attenuator 100 illustrated in FIG. 1, in which the Mach-Zehnder interferometer configured on the optical waveguide circuit is connected in two stages, can be considered (see, for example, Patent Literature 1). For the optical variable attenuator 100, an optical signal input from an input 6 passes through a first Mach-Zehnder interferometer 101 and a second Mach-Zehnder interferometer 102, and is then output from an output 7. The first Mach-Zehnder interferometer 101 includes optical couplers 12 and 13 and arm waveguides 16 and 17, and the second Mach-Zehnder interferometer 102 includes optical couplers 14 and 15 and arm waveguides 18 and 19. The first Mach-Zehnder interferometer is provided with a thermo-optical phase shifter installed above the arm waveguides 16 and 17, and the second Mach-Zehnder interferometer is provided with a thermos-optical phase shifter installed above the arm waveguides 18 and 19. By applying power to these heaters, the interference of light waves in each of the Mach-Zehnder interferometers 101 and 102 is controlled, thereby controlling an optical signal intensity output from the output 7.

It is generally known that an optical waveguide element such as a Mach-Zehnder interferometer has polarization dependence caused by birefringence or other causes, and a loss of polarization dependence is given to an optical signal transmitted through the optical waveguide element (see, for example, Patent Literature 1). For the optical variable attenuator 100 according to the prior art as illustrated in FIG. 1, a groove is formed between the two Mach-Zehnder interferometers 101 and 102, and a ½ wavelength plate 9 is inserted into the groove to eliminate the polarization dependence in order to solve such a problem. That is, the polarization dependence given to the optical signal by the first Mach-Zehnder interferometer 101 is eliminated by giving the same intensity and phase change to orthogonal polarization of the optical signal by rotating the polarization state of the optical signal by 90 degrees and allowing the optical signal to pass through the second Mach-Zehnder interferometer 102.

However, it is necessary to form a groove for inserting a wavelength plate in the prior art, leading to another challenge, in other words, loss. This is because light is emitted from the optical waveguide in the groove, and this has been recognized as an essential and unavoidable challenge.

### CITATION LIST

### Patent Literature

Patent Literature 1: Japanese Patent No. 3337629

### SUMMARY OF INVENTION

### Technical Problem

The present disclosure has been made in view of the above problems, and an object of the present disclosure is to provide an optical waveguide capable of suppressing an optical loss in a groove portion into which a wavelength plate is inserted while eliminating polarization dependence.

### Solution to Problem

Accordingly, the present disclosure provides an optical waveguide, which is an embedded optical waveguide formed on a substrate, including a lower cladding; a core; an upper cladding; and a groove formed on one side of a side surface of the core with respect to a light propagation direction and extending in a direction parallel to the core, wherein a refractive index distribution in a plane perpendicular to the light propagation direction is a distribution in which a principal axis of a refractive index ellipse is rotated by a rotation angle with respect to a horizontal direction of the substrate.

### BRIEF DESCRIPTION OF DRAWINGS

FIG. 1 is a top view schematically illustrating a configuration of an optical variable attenuator 100 in which a Mach-Zehnder interferometer configured on an optical waveguide circuit is connected in two stages according to the prior art.

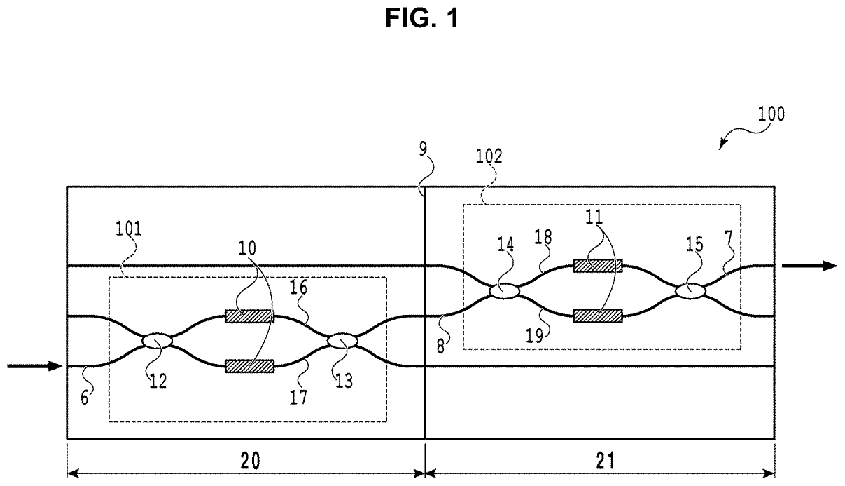

FIG. 2 is a perspective view schematically illustrating a structure of an optical waveguide 200 including a polarization rotator according to the present disclosure.

FIG. 3 is a contour diagram illustrating a refractive index distribution of a plane (xy plane) perpendicular to a light propagation direction near a center of a length L in a z-direction of a groove 205 of the optical waveguide 200 according to the present disclosure, simulated by a finite element method (hereinafter referred to as FEM).

FIG. 4 is a diagram illustrating a calculation result of a minor-axis-major-axis-angle of a refractive index ellipse in a case where a distance (length of w in FIG. 3) between the center of a core 203 and a side wall of the groove 205 is 75 μm.

FIG. 5 is a graph illustrating a relationship between the distance w between the center of the core 203 and the side wall of the groove 205 and a rotation angle of a principal axis of birefringence.

FIG. 6 is a diagram illustrating a calculation result of a difference (birefringence B) between a minor axis and a major axis of the refractive index ellipse under the same conditions as those of the graph illustrated in FIG. 5.

FIG. 7 is a diagram conceptually illustrating polarization rotators for various w in the optical waveguide 200 according to the present disclosure.

### DESCRIPTION OF EMBODIMENTS

Various embodiments of the present disclosure are described in detail below with reference to the drawings. The same or similar reference signs denote the same or similar components, and redundant description may be omitted. The materials and numerical values are for illustrative purposes and are not intended to limit the scope of the disclosure. The following description is an example, and some configurations may be omitted or modified, or may be implemented with additional configurations, without departing from the gist of one embodiment of the present disclosure.

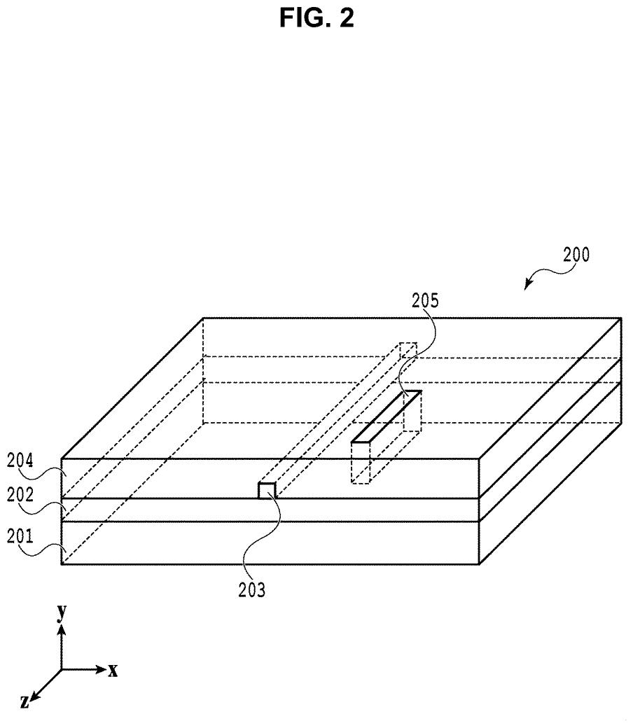

FIG. 2 is a perspective view schematically illustrating a structure of an optical waveguide 200 including a polarization rotator according to the present disclosure. As illustrated in FIG. 2, the optical waveguide 200 is an embedded optical waveguide including a lower cladding 202, a core 203, and an upper cladding 204, which are formed on a substrate 201, and further includes a groove 205 formed on one side of a side surface of the core 203 with respect to a light propagation direction (z-direction in FIG. 2) and extending in a direction parallel to the core 203 (z-direction in FIG. 2). A depth of the groove 205 in the y-direction is not limited as long as the groove imparts a stress distribution to be described later, but the depth is preferably up to immediately above the substrate 201 at the maximum.

A material applied for the optical waveguide 200 illustrated in FIG. 2 may be, for example, silicon, a semiconductor, a ferroelectric, SiOₓ, SiON or SiN. However, a linear expansion coefficient of each of the substrate 201, the lower cladding 202, and the upper cladding 204 satisfies Equation 1, and the upper cladding 204 and the lower cladding 202 need to be formed at temperatures different from the environment temperature for using a device in which the optical waveguide 200 is used.

$${TCE}_{SB} > {TCE}_{OC} or {TCE}_{SB} > {TCE}_{UC} or {TCE}_{OC} > {TCE}_{UC} \qquad ( Equation 1 )$$

TCE_{SB}, TCE_{UC}, and TCE_{OC} are a linear expansion coefficient of the substrate 201, a linear expansion coefficient of the lower cladding 202, and a linear expansion coefficient of the upper cladding 204, respectively.

Hereinafter, as an example, it is assumed that the optical waveguide 200 is a quartz-based optical waveguide using quartz glass, and an operation principle thereof is described.

When fabricating a quartz-based optical waveguide by typical flame hydrolysis deposition, first, a soot glass serving as the lower cladding 202 is deposited on the silicon substrate 201 by flame hydrolysis deposition and held in a high-temperature atmosphere to make the soot glass transparent. A glass layer serving as the core 203 is formed, the glass layer is made transparent similarly to the lower cladding, and then a desired pattern of the core 203 is formed by a method such as photolithography and reactive ion etching. Finally, a glass layer serving as the upper cladding 204 is formed by flame hydrolysis deposition, and is made transparent similarly to the lower cladding 202 and the core 203 to form a quartz-based optical waveguide.

In general, since the transparency temperature of glass is 1000° C. or higher, the temperature of the high-temperature atmosphere when making each glass layer (lower cladding 202, core 203, and upper cladding 204) transparent needs to be at least 1000° C. Under such a high-temperature environment, each glass layer is formed as a glass film by being rapidly cooled after the stress is almost released, resulting in a transparent glass layer. When making each glass layer transparent, there is a difference in linear expansion coefficients between the substrate 201 and the glass layer as shown in Equation 1, and thus internal stress is generated after cooling. More specifically, since the linear expansion coefficient of each glass layer is smaller than the linear expansion coefficient of the substrate 201 (silicon), the substrate 201 has a larger amount of shrinkage due to cooling. However, since each of the glass layers and the substrate 201 are constrained, compressive stress remains inside each glass layer along with the shrinkage behavior of the substrate 201. This compressive stress significantly appears in a horizontal direction (x-direction and z-direction in FIG. 2) with respect to the substrate 201, and similarly, the compressive stress remains in the core 203. On the other hand, for a stress component in a vertical direction (y-direction in FIG. 2) of the substrate 201, since the constraint of the substrate 201 applied to the glass layer has a lesser influence, only the stress caused by the difference in linear expansion coefficients between the core 203 and the upper cladding 204 is applied to the vicinity of the interface between the side surface of the core 203 (a surface parallel to the yz plane in FIG. 2) and the upper cladding 204. However, since a material containing quartz as a main component is adopted for both the core 203 and the upper cladding 204, the difference is small as compared with the linear expansion coefficient difference from the substrate 201, and only a relatively small stress is applied.

Internal stress applied to the core 203 in this manner is different between the horizontal direction (x-direction and z-direction in FIG. 2) with respect to the substrate 201 and the vertical direction (y-direction in FIG. 2) with respect to the substrate 201, and anisotropy occurs in the stress distribution accordingly. This is the cause of birefringence and one of the causes of polarization dependence in various optical devices according to the prior art. The polarization dependence occurs according to a physical phenomenon called the photoelastic effect with respect to a refractive index distribution expressed by Equation 2 and Equation 3:

$${n}_{x} ( x , y ) = {C}_{1} {σ}_{x} ( x , y ) + {C}_{2} ( {σ}_{y} ( x , y ) + {σ}_{z} ( x , y ) ) + {n}_{x 0} ( x , y ) \qquad ( Equation 2 )$$

$${n}_{y} ( x , y ) = {C}_{1} {σ}_{x} ( x , y ) + {C}_{2} ( {σ}_{y} ( x , y ) + {σ}_{z} ( x , y ) ) + {n}_{y 0} ( x , y ) \qquad ( Equation 3 )$$

wherein the light propagation direction is the z-axis, the distributions of stress in the respective axial directions of x, y, and z are denoted by σₓ(x,y), σ_{y}(x,y), and σ_{z}(x,y), and photoelastic coefficients determined by materials are denoted by C₁ and C₂.

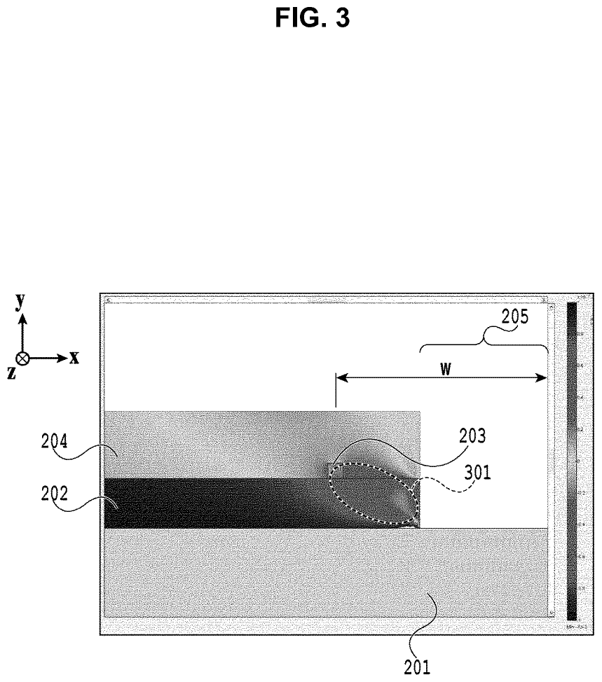

As described above, the optical waveguide 200 according to the present disclosure includes the groove 205 on one side of the side surface of the core 203, and the groove 205 is formed after the upper cladding 204 is formed. By forming the groove 205, the internal stress in the x-direction and the z-direction remaining inside each glass layer is partially released. However, the substrate 201 is restrained in the vicinity of a corner portion where the interfaces with the side wall of the groove 205 and with the substrate 201 intersects (corresponding to a corner portion vicinity 301 in FIG. 3 to be described later) in the lower cladding 202, so that high stress (stress concentration) is locally generated. Since the region where the stress concentration occurs is located in an oblique direction in the xy plane when viewed from the core 203, the stress distribution is asymmetric with respect to the light propagation direction (z-direction in FIG. 2). Therefore, the principal axes of birefringence given by the photoelastic effect represented by Equation 2 and Equation 3 also have a non-axisymmetric distribution with respect to the z-direction.

FIG. 3 is a contour diagram illustrating the refractive index distribution of the plane (xy plane) perpendicular to the light propagation direction near the center of the length L in the z-direction of the groove 205 of the optical waveguide 200 according to the present disclosure, simulated by a finite element method (hereinafter referred to as FEM). FIG. 3 is a cross-section taken along a plane A in FIG. 2. In the FEM calculation, as an example, the substrate 201 is silicon having a thickness (height in the y-direction in FIG. 3) of 500 μm, the lower cladding 202 is glass having a thickness of 10 μm, the upper cladding 204 is glass having a thickness of 20 μm, the core 203 is glass having a thickness and a width (height in the x-direction in FIG. 3) of 6 μm×6 μm, and the transparency temperature of each glass is 1200° C. As illustrated in FIG. 3, in the optical waveguide 200 including the groove 205, there is a region where the refractive index locally changes in the corner portion vicinity 301 where the interface with the side surface of the groove 205 and the interface with the substrate 201 intersect in the lower cladding 202, and a distribution of the region extends to the vicinity of the core 203. This is caused by stress concentration in the portion described above.

In the optical waveguide 200 having such a refractive index distribution, the principal axis of birefringence rotates. That is, in the optical waveguide according to the prior art, the principal axis of birefringence is in the horizontal direction (x-direction in FIG. 3) and the vertical direction (y-direction in FIG. 3) with respect to the substrate 201, whereas in the optical waveguide 200, the principal axis of birefringence can be rotated (inclined) with respect to the horizontal direction of the substrate 201 with the asymmetric stress distribution caused by forming the groove 205. The region where the principal axis of birefringence is inclined serves as the wavelength plate 9 in the prior art, and accordingly, the polarization dependence is eliminated.

The design of the groove 205 is described below.

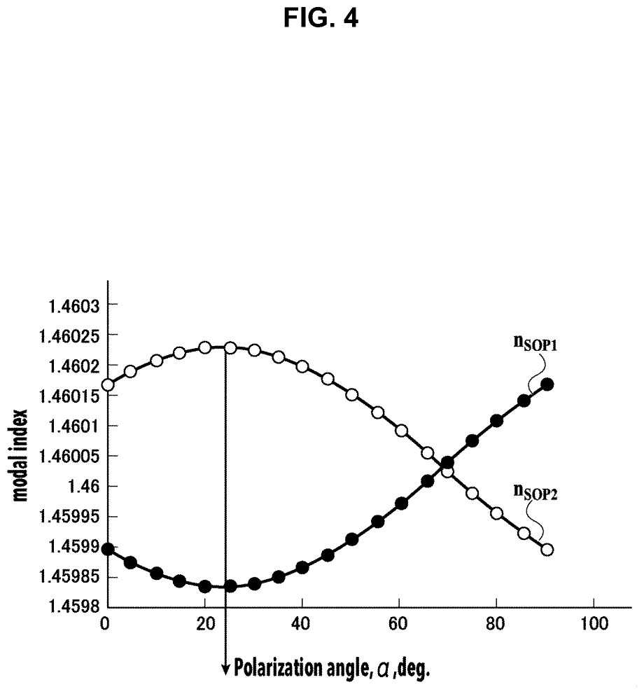

FIG. 4 is a diagram illustrating a calculation result of a minor-axis-major-axis-angle of a refractive index ellipse in a case where a distance (length of w in FIG. 3) between the center of a core 203 and the side wall of the groove 205 closer to the core is 75 μm. In the calculation, conversion into a refractive index distribution is performed using Equation 2 and Equation 3 on the basis of the stress distribution illustrated in FIG. 3, and light mode calculation is performed by the FEM. Note that the result illustrated in FIG. 4 is obtained by assuming two linear polarizations orthogonal to each other as polarization states (also known as “state of polarization”; hereinafter, referred to as SOP) and obtaining the refractive index for each of the linear polarizations for each SOP. A first linearly polarized wave (SOP1) is in a state in which a polarized wave with a magnetic field oscillating in the horizontal direction (x-direction in FIG. 3) with respect to the substrate 201 is zero on the horizontal axis of the graph. A rotation angle for the oscillation angle of the magnetic field in the horizontal direction (x-direction in FIG. 3) with respect to the substrate 201 is shown on the horizontal axis of the graph. Similarly, a second linearly polarized wave (SOP2) is a polarized wave orthogonal to the SOP1, and a position where the horizontal axis of the graph becomes zero is in a direction in which the magnetic field oscillates perpendicular to the substrate. A difference in the refractive indexes is the largest for two orthogonal SOPs at an angle of 25° indicated by an arrow in FIG. 4. This means that the angle formed by the major axis of the refractive index ellipse and the horizontal axis with respect to the substrate 201 is 25°. The minor axis is expected to be a position inclined 90° therefrom. In this way, the rotation angle of the principal axis of the refractive index ellipse (rotation angle of the principal axis of birefringence) with respect to an arbitrary distance w can be obtained.

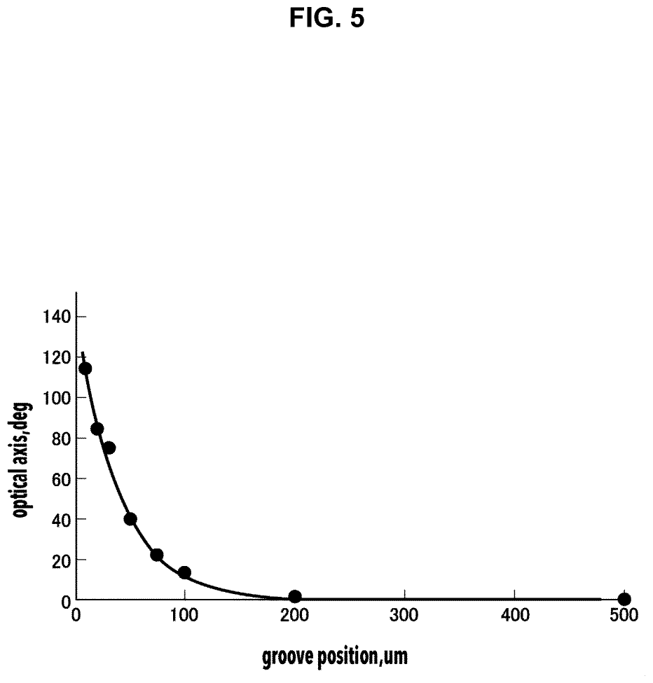

FIG. 5 is a graph illustrating a relationship between the distance w between the center of the core 203 and the side wall of the groove 205 closer to the core and the rotation angle of the principal axis of birefringence. FIG. 5 is obtained by plotting the results obtained in FIG. 4 in which the rotation angle of the principal axis of birefringence with respect to an arbitrary w is calculated for various distances w, and drawing an approximate curve from the plot. From the relationship illustrated in FIG. 5, the value of the distance w with respect to the rotation angle of the principal axis of the desired birefringence can be determined. For example, a λ/2 wavelength plate as a commonly used polarization rotator may rotate the principal axis of birefringence at 45° to rotate the linearly polarized wave by 90°. Therefore, when the distance w at which the principal axis of birefringence is 45° is obtained, it is found that the principal axis of birefringence is 45° when the distance w is about 46 μm as illustrated in FIG. 5.

With the distance w between the center of the core 203 and the side wall of the groove 205, calculated by such a method, the position of the groove 205 with respect to the position of the core 203 is determined.

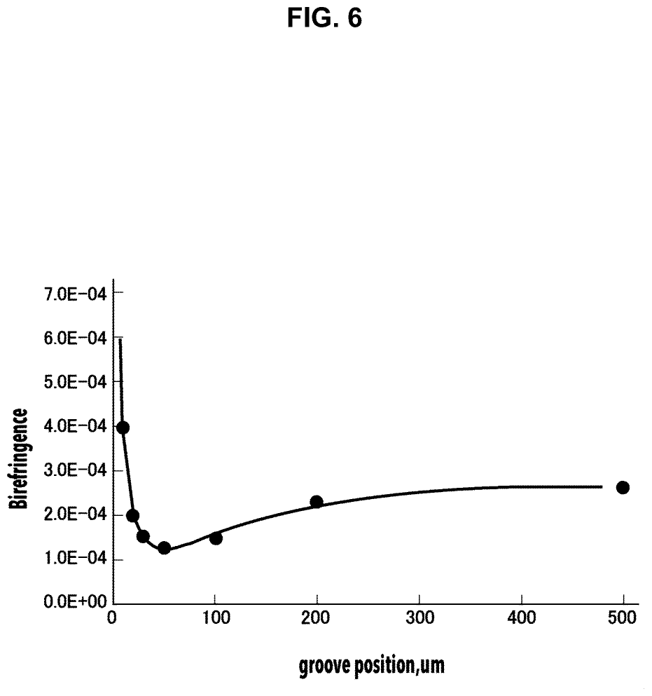

FIG. 6 is a diagram illustrating a calculation result of a difference (birefringence B) between a minor axis and a major axis of the refractive index ellipse under the same conditions as those of the graph illustrated in FIG. 5. As described above, for example, when the rotation angle of the principal axis of birefringence is 45°, the birefringence B can be 1.3×10⁻⁴ as determined from FIG. 6.

A phase difference (retardation) due to birefringence can be expressed by Equation 4 based on the birefringence B and the length L in the direction (z-direction in FIG. 3) parallel to the light propagation direction of the groove 205. In other words, the length L of the groove 205 in the direction parallel to the light propagation direction (z-direction in FIG. 3) can be obtained using Equation 4 from the birefringence B (for example, when θ=45°, B=1.3×10⁴) at the rotation angle θ of the principal axis of arbitrary birefringence and the desired retardation.

$$B ( θ ) \times L = Desired Retardation \qquad ( Equation 4 )$$

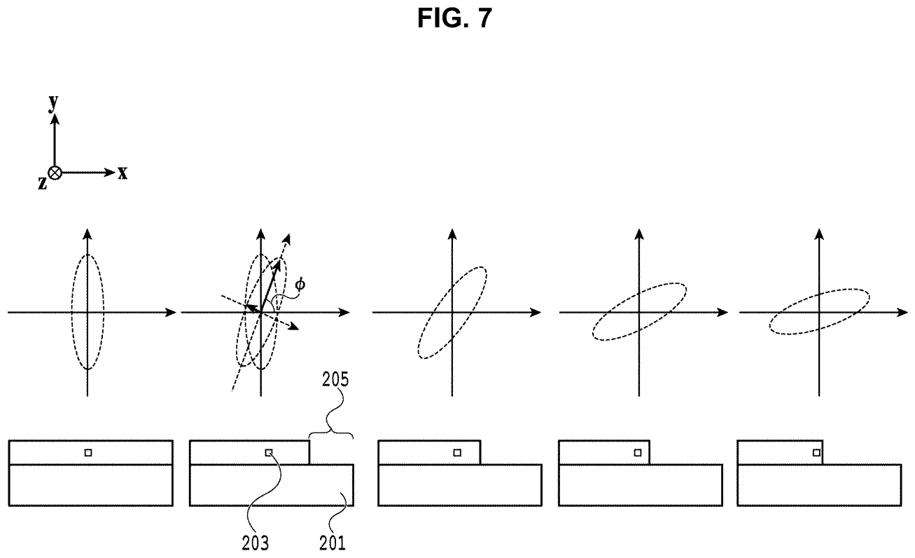

FIG. 7 is a diagram conceptually illustrating polarization rotators for various w in the optical waveguide 200 according to the present disclosure. In a case where the groove 205 is not formed in the vicinity of the core 203 of the optical waveguide 200, the principal axis of the birefringence ellipse is set in the direction (vertical direction) perpendicular to the substrate plane, whereas if the groove 205 is formed in one of the optical waveguides, the birefringence ellipse rotates more greatly as the distance between the side wall of the groove 205 and the core 203 approaches (the distance w increases).

As described above, in the optical waveguide 200 according to the present disclosure, the stress distribution in the plane perpendicular to the light propagation direction is controlled by the formation of the groove 205, and the polarization dependence can be eliminated by giving (inclining by) the rotation angle to the principal axis of the birefringence. The optical waveguide 200 having such a configuration does not need a wavelength plate and a groove for inserting the wavelength plate, which are required in the prior art. Therefore, the loss of light in the groove portion is suppressed, and light can be propagated with high efficiency while eliminating the polarization dependence.

### INDUSTRIAL APPLICABILITY

As described above, the optical waveguide according to the present disclosure can suppress the loss of light in the groove for disposing the wavelength plate, and thus it is possible to propagate light with higher efficiency than the prior art for eliminating the polarization dependence. Such an optical waveguide is expected to be adopted for optical devices in optical communication networks where a large capacity is desired.

1. An optical waveguide, that is an embedded optical waveguide formed on a substrate, comprising:
a lower cladding;
a core;
an upper cladding; and
a groove formed on one side of a side surface of the core with respect to a light propagation direction and extending in a direction parallel to the core,
wherein a refractive index distribution in a plane perpendicular to the light propagation direction near a center of a length of the groove in a direction parallel to the light propagation direction is a distribution that a principal axis of a refractive index ellipse is rotated by a rotation angle with respect to a vertical direction of the substrate plane.

2. The optical waveguide according to claim 1, wherein a distance between a side wall of the groove closer to the core and a center of the core is set based on an angle of the principal axis of the refractive index ellipse determined as an angle that a refractive index difference is the largest with respect to two orthogonal polarization states.

3. The optical waveguide according to claim 1, wherein the length of the groove in the direction parallel to the light propagation direction is set based on a difference between a minor axis and a major axis of the refractive index ellipse and a retardation.

4. The optical waveguide according to claim 1, wherein linear expansion coefficients TCE_{SB}, TCE_{UC}, and TCE_{OC} of the substrate, the lower cladding, and the upper cladding satisfy Equation 1.
$${TCE}_{SB} > {TCE}_{OC} or {TCE}_{SB} > {TCE}_{UC} or {TCE}_{OC} > {TCE}_{UC} \qquad ( Equation 1 )$$
